(19) United States
(12) Patent Application Publication
(10) Pub. No.: US 2009/0232975 A1
(43) Pub. Date: Sep. 17, 2009

(54) METHOD FOR REPAIRING TURBINE VANES

(75) Inventor: Thomas Cosack, Windach (DE)

Correspondence Address: CROWELL & MORING LLP;INTELLECTUAL PROPERTY GROUP, P.O. BOX 14300, WASHINGTON, DC, 20044-4300, US

(73) Assignee: MTU Aero Engines GmbH, Munich (DE)

(21) Appl. No.: 11/721,317

(22) PCT Filed: Dec. 7, 2005
(86) PCT No.: PCT/DE2005/002204

§ 371 Date: Jun. 8, 2007

(30) Foreign Application Priority Data
Dec. 11, 2004 (DE) 10 2004 059 762.6

(51) Int. Cl. B32B 43/00; B23P 6/04

(52) U.S. Cl. 427/142

(57) ABSTRACT

A method for repairing turbine vanes for a gas turbine is disclosed. In an embodiment, the method includes the following steps: a) a turbine vane is provided which, at least in sections, has a PtAl coating to be repaired, b) the turbine vane is cleaned at least in the area of the PtAl coating to be repaired, and c) the turbine vane is alitized only in the area of the cleaned PtAl coating.

This application claims the priority of International Application No. PCT/DE2005/002204, filed Dec. 7, 2005, and German Patent Document No. 10 2004 059 762.6, filed Dec. 11, 2004, the disclosures of which are expressly incorporated by reference herein.

### BACKGROUND AND SUMMARY OF THE INVENTION

The invention relates to a method for repairing turbine vanes of a gas turbine.

Turbine vanes and stator blades of a turbine, especially of a high-pressure turbine for a gas turbine aircraft engine, are coated on their surfaces with a PtAl coating, or platinum-aluminum coating, to provide a hot gas corrosion protection layer or to provide a thermal insulation layer. During operation, this PtAl coating wears so that the PtAl coating has to be repaired or refaced from time to time.

The procedure according to the prior art to repair turbine vanes in the area of their PtAl coating is to completely strip the turbine vanes so that after stripping only the base material of the turbine vanes is left. After the complete stripping, a new PtAl coating is built up by platinizing and alitizing the turbine vanes. Completely stripping the turbine vanes is complicated and expensive. Furthermore, building up a completely new PtAl coating is similarly complicated and expensive.

With this as the point of departure, the problem of the present invention is to create a novel method for repairing turbine vanes of a gas turbine.

In accordance with the invention, the method comprises at least the following steps: a) a turbine vane is provided which has, at least in sections, a PtAl coating to be repaired; b) the turbine vane is cleaned at least in the area of the PtAl coating to be repaired; c) the turbine vane is alitized only in the area of the cleaned PtAl coating.

With the present invention, it is provided for the first time to repair a PtAl coating of a turbine vane only by alitizing after cleaning the PtAl coating to be repaired. The invention is based on the knowledge that following cleaning and minor stripping as needed of a turbine vane to be repaired residual coatings remain on the surface with a sufficient platinum content so that, simply by alitizing, a PtAl coating with good hot-gas corrosion properties and oxidation protection properties can be provided.

Preferred refinements of the invention are found in the description hereinafter. Embodiments of the invention are explained in more detail using the drawing, without being limited thereto.

### BRIEF DESCRIPTION OF THE DRAWING

FIG. 1 shows a heavily schematized view of a turbine vane to be repaired.

### DETAILED DESCRIPTION OF THE DRAWING

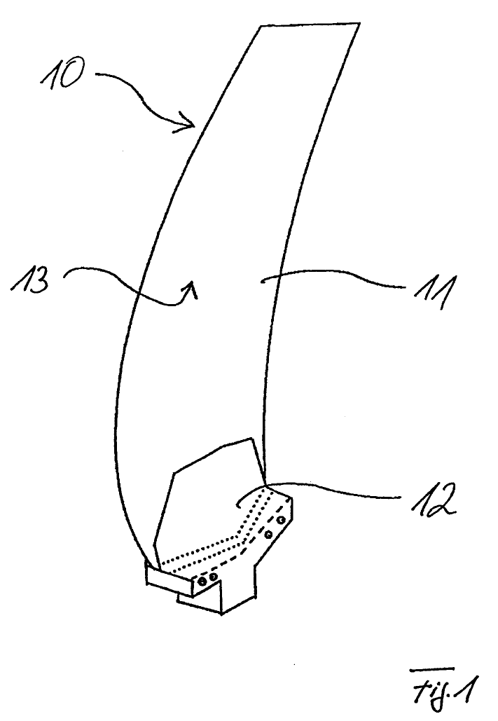

The present invention will be described in greater detail hereinafter with reference to FIG. 1.

FIG. 1 shows a turbine vane 10 for a gas turbine aircraft engine which has a turbine blade 11 and a blade root 12. The turbine vane 10 has a PtAl coating 13 in the area of its blade 11 to provide hot-gas corrosion protection. During operation of the gas turbine, the PtAl coating may wear so that refacing or repair of the PtAl coating 13 becomes necessary.

To repair the turbine vane 10 in the area of the PtAl coating 13, the procedure within the meaning of the method in accordance with the invention is that the turbine vane 10 is cleaned at least in the area of the PtAl coating to be repaired.

Following cleaning, a relatively thin layer close to the surface of the PtAl coating to be repaired is removed from the PtAl coating 13 to be repaired. A layer on the order of 10 μm maximum, preferably 5 μm maximum, is removed from the PtAl coating to be repaired.

This cleaning and/or removal is carried out mechanically preferably by high-pressure water jets. Alternatively, the cleaning and/or removal can be carried out chemically.

Following the cleaning and any necessary removal, the repair or refacing of the PtAl coating is carried out by alitizing the turbine vane 10 at least in the area of the cleaned PtAl coating. The residual coating remaining after cleaning and any removal needed contains sufficient platinum whose potential can be used to build up a renewed PtAl coating. By only alitizing, that is by introducing pure aluminum, a PtAl coating with full usability can be produced afterwards.

Alitizing of the cleaned PtAl coating can be carried out in the usual way by powder pack alitizing, gas phase alitizing or by alitizing in accordance with a slip process.

By using the method in accordance with the invention, turbine vanes can be repaired in the area of their PtAl coating in a particularly simple, rapid and cost-effective way. Within the meaning of the invention, complicated stripping or removal of the entire PtAl coating can be eliminated. Furthermore, in accordance with the method from the invention, a renewed application of expensive platinum is not necessary.

1-6. (canceled)

7. A method for repairing a turbine vane for a gas turbine, comprising the steps of:
a) cleaning the turbine vane in an area of a PtAl coating requiring repair; and
b) repairing the turbine vane in the area of the PtAl coating by only alitizing the turbine vane in the area of the cleaned PtAl coating.

8. The method according to claim 7, further comprising the step of removing a relatively thin layer from the PtAl coating to be repaired.

9. The method according to claim 8, wherein the relatively thin layer has a maximum thickness of 10 μm.

10. The method according to claim 8, wherein the relatively thin layer has a maximum thickness of 5 μm.

11. The method according to claim 8, wherein the cleaning and/or removing is performed mechanically.

12. The method according to claim 11, wherein the cleaning and/or removing is performed by water jets.

13. The method according to claim 8, wherein the cleaning and/or removing is performed chemically.

14. The method according to claim 7, wherein the area of the cleaned PtAl coating includes a platinum coating.

15. The method according to claim 7, wherein the step of cleaning the turbine vane in the area of the PtAl coating requiring repair leaves a residual platinum coating on the turbine vane in the cleaned area.

16. The method according to claim 15, wherein the residual platinum coating covers a base material of the turbine vane.
